(19) United States
(12) Patent Application Publication
(10) Pub. No.: US 2011/0176181 A1
(43) Pub. Date: Jul. 21, 2011

(54) Multi-Item Scanning on a Vertically Oriented Scanner

(76) Inventor: Mark Walter Fagan, Lexington, KY (US)

(21) Appl. No.: 12/688,936

(22) Filed: Jan. 18, 2010

(51) Int. Cl. H04N 1/04

(52) U.S. Cl. 358/474

(57) ABSTRACT

An imaging device for imaging an original allows a user to position an original on a lid of the imaging device. The document is positioned on the lid with images of the document facing the user. The imaging device including an imaging unit disposed within a housing, an imaging surface disposed in an imaging relationship with the imaging unit within the housing, the imaging unit captures an image of the original when positioned adjacent to the imaging surface. The lid is pivotably coupled to the housing for moving between a closed position and an open position. The lid includes an inner surface for supporting the original disposed on the lid, and an original retaining member attached to the lid for selectively retaining the original on the inner surface between the open position and the closed position. The inner surface of the lid positions the original adjacent to the imaging surface in the closed position and moves the original away from the imaging surface in the open position.

### CROSS REFERENCE TO RELATED APPLICATION

This application claims the benefit of the earlier filing date of Application Ser. No. 61/139,921, filed Dec. 22, 2008, entitled “Multi-Item Scanning on a Vertically Oriented Scanner.” This application is also related to application Ser. No. 11/778,910, filed Jul. 17, 2007, entitled “All-In-One Device with Integral Monitor.” The present application hereby incorporates by reference the above applications in their entirety.

### BACKGROUND

1. Field of the Invention

The present invention generally relates to imaging devices and, more particularly, to imaging devices that perform multi-item scanning during a single scanning operation.

2. Description of the Related Art

An imaging device, for example, a scanner, is typically used in a traditional mode where a lid of the imaging device is opened and a document, having images therein, is placed on a scan glass of the imaging device. The images of the document facing the scan glass are imaged/scanned by a scanning unit disposed within the imaging device. The scanned images may be printed on a print media as desired by a user or transmitted to an external device or host.

However, there are substantial limitations to imaging the document positioned on the scan glass of such imaging devices. One such limitation is that the user cannot actually see exactly how the document will be scanned as the images face the scan glass and there is a possibility that the user skews the document and does not know it until the imaging operation is performed. As a result, the user may receive final scanned images having an improper orientation with regard to the original document. This limitation becomes extremely significant when a plurality of documents, such as pictures, business cards, receipts, etc., is positioned on the scan glass. Thus, the user looses flexibility in scanning the plurality of documents in the traditional method.

Thus, there is a need to provide an imaging device that addresses at least some of the above problems yet providing a quality scanned image for the user.

### SUMMARY OF THE INVENTION

Disclosed herein is an imaging device for imaging an original including an imaging unit disposed within a housing, an imaging surface disposed in an imaging relationship with the imaging unit within the housing, the imaging unit capturing an image of the original when positioned adjacent to the imaging surface, and a lid pivotably coupled to the housing for moving between a closed position and an open position The lid includes an inner surface for supporting the original disposed on the lid, and an original retaining member attached to the lid for selectively retaining the original against the inner surface. The retaining member maintains the original in a stable position relative to the inner surface of the lid such that there is little if any movement of the original when the lid is moved from the open to the closed position. When the lid is in the closed position, the original is positioned against the imaging surface for having its content captured by the imaging unit.

In some embodiments, the lid is pivotably coupled to the housing along an edge of the inner surface to rotate between the closed position and the open position. Further, the retaining member may be pivotably attached to the lid so that original may be placed and secured against the inner surface of the lid when the retaining member is pivoted in an open position, relative to the lid.

In some embodiments, the imaging surface is disposed in an inclined orientation, such as a substantially vertically orientation, within the housing such that the lid and the original retaining member are disposed in a non-horizontal position adjacent to the imaging surface when the lid is in the closed position.

In some embodiments, the original retaining member is detachably attached to the inner surface of the lid.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

### BRIEF DESCRIPTION OF THE DRAWINGS

The above-mentioned and other features and advantages of the various embodiments of the invention, and the manner of attaining them, will become more apparent will be better understood by reference to the accompanying drawings, wherein:

FIG. 1 is a perspective view of one embodiment of a vertically oriented imaging device according to the present invention having a lid pivotally coupled thereto and disposed in a closed position;

FIG. 2 shows a partial perspective view of a scan unit disposed within the vertically oriented imaging device of FIG. 1 having the lid retaining an original and disposed in an open position; and

FIG. 3 shows a perspective view of an original retaining member attached to the lid of FIG. 1.

### DETAILED DESCRIPTION

Reference will now be made in detail to the exemplary embodiment(s) of the invention, as illustrated in the accompanying drawings. Whenever possible, the same reference numerals will be used throughout the drawings to refer to the same or like parts.

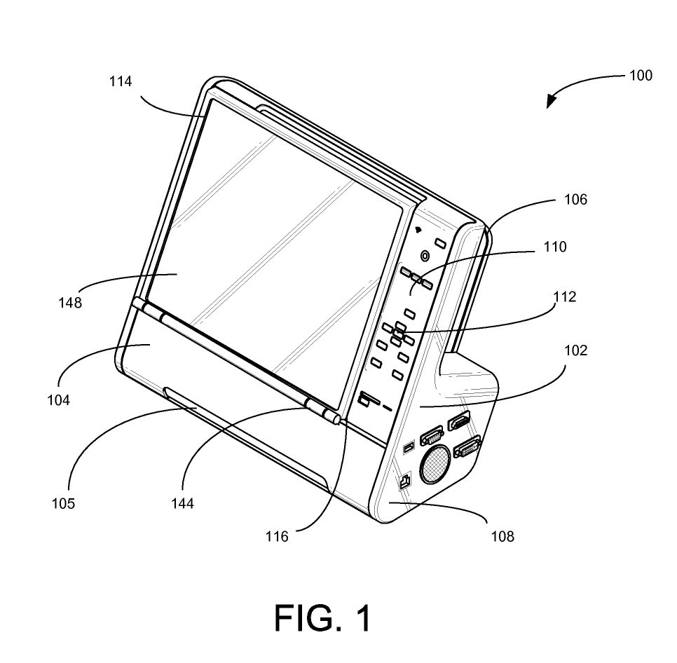

FIG. 1 illustrates a perspective view of an embodiment of an imaging device 100 according to an exemplary embodiment of the present invention. The imaging device 100, which may be a standalone imaging device 100, includes a housing 102 having a front portion 104, a back portion 106, and a base 108. The front portion 104 of the housing 102 has an imaging surface 136 disposed thereon (best seen in FIG. 3). Further, a user interface 110 having a plurality of selection buttons 112 is also disposed on the front portion 104 of the housing 102. A user may selectively actuate the selection buttons 112 for performing any of a number of imaging related operations, such as a scan or print operations.

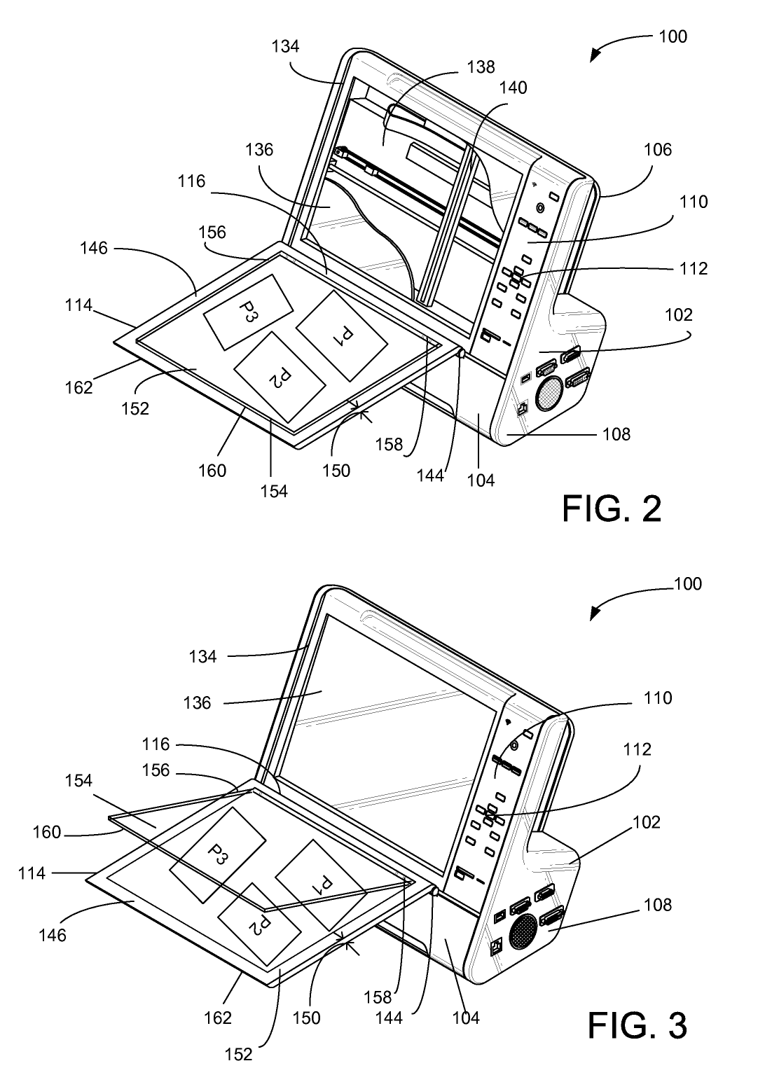

Further, as shown in FIG. 1, the imaging device 100 includes a lid 114 pivotally connected to the front portion 104 of the housing 102. The lid 114 is pivotably connected along a bottom edge 116 thereof to the front portion 104 of the housing 102 via hinges 144 to allow the lid 114 to move between a closed position as shown in FIG. 1 and an open position as shown in FIGS. 2 and 3. The back portion 106 of the imaging device 100 has an input media tray that may retain one or more print media sheets therein. The base 108 is constructed to have a substantially flat wide area to allow the imaging device 100 to be positioned on any substantially flat horizontal surface as desired by the user. A media output area 105 may be positioned along a lower part of front portion 104.

Imaging device 100 may include a print engine (not shown) for printing an image onto a sheet of media. The print engine may include various types of printing mechanisms including dye-sublimation, dot-matrix, ink jet or laser printing. For ease of description, the exemplary print engine may be an inkjet printing device although such description should not be considered limiting. The print engine may include a carriage having a position for placement of at least one print cartridge. According to the exemplary embodiment, two print cartridges may be utilized wherein, by way of example, a color cartridge is utilized for color printing and a black cartridge for text or other monochrome printing. As one skilled in the art will recognize, the color cartridge may include three inks, i.e., cyan, magenta and yellow inks. As an alternative, a single black cartridge may be used.

In another alternative embodiment, one or more printheads may be disposed in the carriage and one or more ink containers may be in fluid communication with the one or more printheads. In yet another alternative embodiment, at least one stationary printhead is disposed across a media path and at least one ink container may be in fluid communication with the at least one printhead.

Imaging device 100 may include one or more mechanisms (not shown) for picking a sheet of media from the media input tray, moving the picked sheet to be adjacent the print engine for printing an image thereon, and moving the picked sheet having the printed image to output area 105. During advancement, the picked media sheet moves from the input media tray to the media output area 105 along a substantially L-shaped media.

FIG. 2 illustrates a perspective view of the imaging device 100 with the lid 114 disposed in the open position and with an area behind imaging surface 136 exposed for illustrative purposes. The front portion 104 of the housing 102 includes an opening 134 formed thereon adjacent to the user interface 110. The opening 134 retains an imaging surface 136 therein and positioned at a predetermined distance from an outer surface of the user interface 110. The imaging surface 136 is disposed in an inclined position at an acute angle relative to the horizontal. In one embodiment, imaging surface 136 may be at a near a vertical orientation, such as about 68 degrees. As shown in FIG. 1, a remainder portion of the opening 134 adjacent to the near vertically oriented imaging surface 136 is covered by the lid 114 when the lid 114 is disposed in the closed position with respect to the front portion 104.

Referring to FIG. 2, an imaging unit 138 disposed within the housing 102 of the imaging device 100 is illustrated. The imaging unit 138 may include a reciprocating scan bar 140 and scan-related components disposed within the housing 102. The reciprocating scan bar 140 and the scan related components are disposed adjacent to the inner surface of imaging surface 136 and are in imaging relationship thereto. Further, the scan bar 140 reciprocates laterally in side-to-side directions with respect to the imaging surface 136 to perform scanning operation on one or more originals P1-P3 positioned adjacent to the imaging surface 136. During an imaging operation, the scan bar 140 captures images of originals P1-P3 and stores the captured images in a memory of a microprocessor unit (not shown) of the imaging device 100.

Alternatively, instead of utilizing a scan bar 140 for capturing an image of one or more originals P1-P3 a few scan lines at a time, imaging device 100 may capture substantially the entire image of the media sheet at one time. By capturing an entire image substantially simultaneously, scan bar 140 and its corresponding drive mechanism are not utilized. In this alternative embodiment, imaging device 100 may include light sources of sufficient number and placement to generate and direct light towards one or more originals P1-P3 disposed against imaging surface 136 so that light reflections may be captured by one or more image sensors.

As shown in FIGS. 2 and 3, the lid 114 may be disposed in the open position. The lid 114 is connected by hinge 144 to the front portion 104 along a lower edge of the opening 134 so as to rotate between the closed position and the open position. In another embodiment of the imaging device 100 according to the present invention, the lid 114 may be attached along other edges of the opening 134. Further, other mechanisms may also be used to open and close the lid 114 against the front portion 104 of the housing 102 and be within the scope of the present invention.

The lid 114 has an inner surface 146 and an outer surface 148 (shown in FIG. 1) and is dimensioned to have a thickness 150 extending between the inner surface 146 and the outer surface 148. Further, the lid 114 is dimensioned to have an overall size that it is substantially equal to a size of the opening 134 formed on the front portion 104 of the housing. Thus, as seen in FIG. 1, when the lid 114 is disposed in the closed position against the front portion 104 of the housing 102, the thickness 150 of the lid 114 occupies the remainder portion of the opening 134 to properly fit the lid 114 therein. This closed position of the lid 114 allows the outer surface 148 thereof to be positioned at the same level as that of the outer surface of the user interface 110. Such arrangement of the lid 114 within the opening 134 of the front portion 104 of the housing 102 ensures that the lid 114 and its inner surface 146 are securely disposed within the opening 134 against the imaging surface 136. Furthermore, this arrangement also ensures that the originals P1-P3, which are disposed in between the imaging surface 136 and the lid 114, are properly imaged by the imaging unit 138. The imaging surface 136 may be made from a transparent material such as glass or a like material.

Further, as shown in FIGS. 2 and 3, a supporting portion 152 of the inner surface 146 of the lid 114 supports one or more originals P1-P3 to be imaged. The originals P1-P3, may include one or more media sheets, business cards, receipts, etc. The originals P1-P3 may be positioned on the inner surface 146 of the lid 114 with the images facing the user. Positioning of the originals P1-P3 in this manner allows the user to actually see the exact orientation of the originals P1-P3 and would therefore allow the user to correct any misorientation thereof, which might otherwise have occurred during positioning of the original P1-P3 on the inner surface 146 of the lid 114, before the imaging operation starts. One benefit for the user is that a single imaging operation will be sufficient to image all of the documents. Another benefit of such positioning is that user has enough flexibility to do some creative scans/copies with the plurality of documents where the user creates collages. Such creative scan/copies become possible since the user can see what the final imaged document will look like.

FIGS. 2 and 3 also illustrate a perspective view of an original retaining member 154 attached to the inner surface 146 of the lid 114. The original retaining member 154 has a connected end portion 156 that is pivotably connected to the inner surface 146 of the lid 114 and positioned adjacent to the bottom edge 116 of the lid 114. The pivotable connection includes a hinged connection 158 between the original retaining member 154 and the inner surface 146 of the lid 114 to allow the original retaining member 154 to move between a closed position and an open position against the lid 114. Further, the original retaining member 154 also has an unconnected end 160 that may be secured to the inner surface 146 of the lid 114 adjacent a top edge 162 thereof, as shown in FIG. 3. Further, the original retaining member 154 has a size that is substantially equal to an area of the supporting portion 152 of the inner surface 146 of the lid 114. Alternatively, the original retaining member 154 may also be sized that is substantially equal to an area inner surface 146 of the lid 114.

FIGS. 2 and 3 illustrate the original retaining member 154 being disposed in the closed position and the open position with respect to lid 114, respectively. With original retaining member 154 in the open position, the user may remove the originals P1-P3 from the supporting portion 152 of the lid 114 and may replace them with a new original to be scanned.

When original retaining member 154 is in the closed position, the original retaining member 154 applies a slight pressure on the originals P1-P3 against the inner surface 146 of the lid 114 resulting in stably securing the originals P1-P3 against the inner surface 146 of the lid 114. For instance, a spring (not shown) may be coupled to original retaining member 154 and lid 114 so as to bias the unconnected end 160 of original retaining member 154 against lid 114. Alternatively the supporting portion 152 may be of backed by a foam material providing a spring surface so when retaining member 154 is in the closed position a slight pressure on the originals P1-P3 results. So, as the lid 114 moves between the open position and the closed position, the original retaining member 154 securely holds the originals P1-P3 against the inner surface 146 of the lid 114 during movement of the lid 114 between the two positions. Thus, a benefit of disposing the original retaining member 154 on the inner surface 146 of the lid 114 supporting the originals P1-P3 is that the originals P1-P3 remain intact in their respective positions and any misorientation of the originals P1-P3 caused due to movement of the lid 114 is avoided. Additionally, misorientation that may be caused by the gravitational forces acting on the originals P1-P3 when the lid 114 is disposed in the closed position is also avoided.

Furthermore, when the lid 114 is disposed in the closed position against the imaging surface 136 the originals P1-P3, which are disposed on the inner surface 146 of the lid 114 and slightly pressed by the original retaining member 154, is positioned adjacent to the imaging surface 136. Thus, the originals P1-P3 are not supported directly on the vertically oriented imaging surface 136 and there is not physical contact between the two. Rather, the originals P1-P3 are held by the original retaining member 154 against the inner surface 146 of the lid 114 and positioned adjacent to the imaging surface 136. Thereafter, upon proper selection of the selection buttons 112, the imaging unit 138 captures the images appearing on the originals P1-P3.

In the above embodiment of the imaging device 100 according to the present invention, the original retaining member 154 is attached by a hinged connection 158 to the inner surface 146 of the lid 114. However, there could be many ways to securely hold the originals P1-P3 against the inner surface 146 of the lid 114. In one embodiment of the imaging device 100 according to the present invention, the original retaining member 154 may be pivotably connected to the scan lid 114 along one side thereof and include a clasp or latch mechanism for securing an opposite side to the scan lid 114. Alternatively, original retaining member 154 may be held against lid 114 by a snap-fit engagement therewith. In another embodiment, the original retaining member 154 may be slidingly engaged with the lid 114 by sliding in an opening defined along the lid 114. Other mechanisms may also be utilized for detachably securing the original retaining member 154 to the lid 114 and be within the scope of the present invention.

Further, the original retaining member 154 may be made from a transparent or translucent material such as glass. However, the original retaining member 154 may be made from virtually any composition, such a plastic composition, so long as it is substantially transparent and/or allows for the imaging unit 138 to accurately capture an image of the originals P1-P3. Furthermore, the transparent material from which the original retaining member 154 is made may be flexible or may be made be rigid.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An imaging device for imaging an original comprising:
an imaging unit disposed within a housing;
an imaging surface disposed in an imaging relationship with the imaging unit within the housing, the imaging unit captures an image of the original when positioned adjacent to the imaging surface; and
a lid pivotably coupled to the housing for moving between a closed position and an open position, the lid including:
an inner surface for supporting the original disposed on the lid; and
an original retaining member attached to the lid for selectively retaining the original on the inner surface between the open position and the closed position, wherein the inner surface of the lid positions the original adjacent to the imaging surface in the closed position and moves the original away from the imaging surface in the open position.

2. The imaging device according to claim 1, wherein the lid is pivotably coupled to the housing along an edge of the inner surface to rotate between the closed position and the open position.

3. The imaging device according to claim 1, wherein the original retaining member is detachably attached to the inner surface of the lid.

4. The imaging device according to claim 1, wherein a size of the inner surface of the lid is substantially equal to the size of the imaging surface.

5. The imaging device according to claim 1, wherein the imaging surface is disposed in a substantially vertically orientation within the housing such that the lid and the original retaining member are substantially vertically disposed adjacent to the imaging surface when the lid is in the closed position.

6. The imaging device according to claim 1, wherein the original retaining member is made from a flexible material.

7. The imaging device according to claim 1, wherein the imaging unit includes a scan bar disposed in an imaging relationship with the imaging surface for scanning the original positioned adjacent to the imaging surface.

8. The imaging device according to claim 1, wherein the original retaining member is substantially translucent.

9. An imaging device for imaging an original comprising:
a housing;
an imaging unit disposed within the housing;
an imaging surface disposed in a substantially vertically orientation within the housing and in an imaging relationship with the imaging unit, the imaging unit captures an image of the original when positioned adjacent to the imaging surface; and
a lid pivotably coupled to the housing for moving between a closed position and an open position, the lid including:
an inner surface for supporting the original disposed on the lid; and
an original retaining member attached to the lid for selectively retaining the original on the inner surface between the open position and the closed position, wherein the inner surface and the original retaining member are substantially vertically disposed to position the original adjacent to the imaging surface in the closed position and moves the original away from the imaging surface in the open position.

10. The imaging device according to claim 9, wherein the lid is pivotably coupled to the housing along an edge of the inner surface to rotate between the closed position and the open position.

11. The imaging device according to claim 9, wherein the original retaining member is detachably attached to the inner surface of the lid.

12. The imaging device according to claim 9, wherein a size of the inner surface of the lid is substantially equal to the size of the imaging surface.

13. The imaging device according to claim 9, wherein the original retaining member is made from a flexible material.

14. The imaging device according to claim 9, wherein the imaging unit includes a scan bar disposed in an imaging relationship with the imaging surface for scanning the original positioned adjacent to the imaging surface.

15. The imaging device according to claim 9, wherein the original retaining member is substantially translucent.
